(19) United States
(12) Patent Application Publication
(10) Pub. No.: US 2008/0313272 A1
(43) Pub. Date: Dec. 18, 2008

(54) METHOD FOR COOPERATIVE DESCRIPTION OF MEDIA OBJECTS

(75) Inventors: Hang NGUYEN, Bretigny-sur-Orge (FR); Gerard Delegue, Cachan (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/137,758

(22) Filed: Jun. 12, 2008

(30) Foreign Application Priority Data
Jun. 15, 2007 (FR) 0704255

(51) Int. Cl. G06F 15/16

(52) U.S. Cl. 709/203

(57) ABSTRACT

A method for the description of a media object (6), said method comprising the following steps:

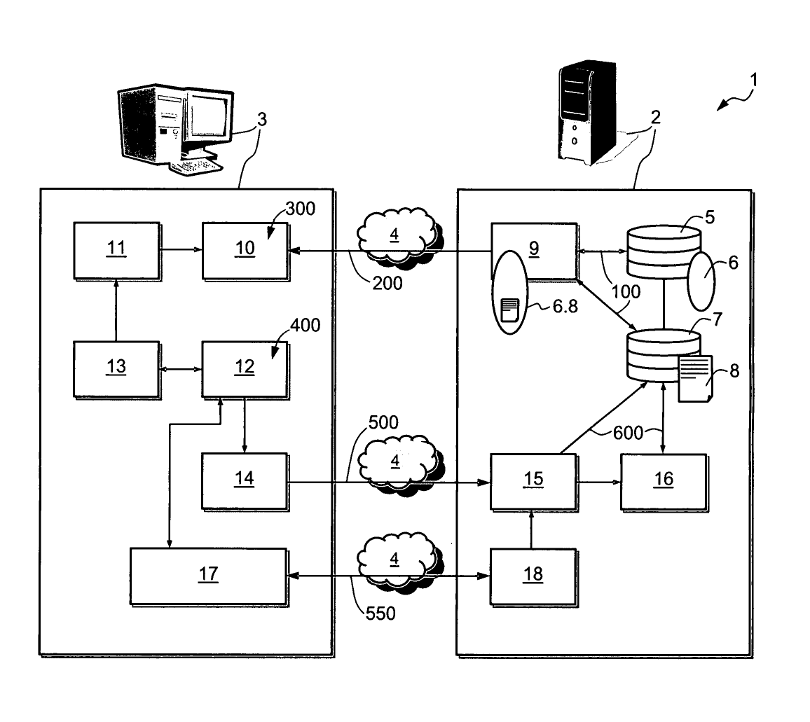

selecting a media object (6) from within a server (2) and a description (8) of said media object (6);

transmitting the media (6), accompanied by its description (6), to a client terminal (3) connected to the server (2);

reconstructing the media object (6) and its description (8) on one interface (10) of the terminal (3);

acquiring new description elements of the media (6) within the terminal (3);

transmitting the new description elements from the terminal (3) to the server (2);

updating the description (8) of the media object (6) within the server (2), taking into account the new description elements.

### BACKGROUND OF THE INVENTION

The invention pertains to the description of the content of media objects.

Until recently, search engines such as Google® or Yahoo® could only be used to run searches from among text objects.

As the need is becoming urgent to be able to run searches from among multimedia objects (i.e. non-text objects: video, audio, images), due to the increasing number of such objects being stored and/or exchanged, solutions for indexing them have been proposed. The solutions vary technically depending on the nature of the media object in question, but the principle remains the same: analyzing the content of the media and creating a semantic description thereof. For example, for video objects, one description standard—now recognized—is the standard MPEG-7 (Moving Picture Experts Group).

The description may be created on various semantic levels, depending on how it is used. Thus, if the description is intended to be stored as an attachment to the media to be used later in search run using robots, the description may be low-level abstraction. If, on the other hand, the description must be reconstructed on a user interface for human reading, a high-level abstraction is required.

For a visual object (video, for example), a low-level abstraction gives a description of the following elements: shape, size, texture, color, and composition, whereas a high-level abstraction gives semantic information in natural language. (cf. Guy Pujolle, Les Réseaux, 5^{th} edition, 2005, p. 953).

One application for analyzing the content of audio media objects is outlined in J M Van Thong et. al., Multimedia Content Analysis and Indexing: Evaluation of a Distributed and Scalable Architecture (HP Laboratories, Cambridge, August 2003).

Certain techniques are also patented: These include, in particular, those disclosed in American patents U.S. Pat. No. 6,236,395 and U.S. Pat. No. 7,134,074, and in American patent application US 2005/0108775.

Though a low-level abstraction may prove useful for indexing media objects into predetermined categories, high-level abstraction is essential for applications intended for the general public (such as television or telephony). Some proposals have been made to enable the reconstruction of metadata (used for the content description) on general-public interfaces in a broadcast universe, cf. American patent application US 2002/0116471.

However, a major drawback of known solutions is their lack of interactivity. The invention particularly intends to remedy this disadvantage.

### SUMMARY OF THE INVENTION

To that end, the invention discloses a method for describing media, comprising the following steps:
selecting a media object and a description thereof from within a server.
transmitting the media, accompanied by its description, to a client terminal connected to the server;
reconstructing the media object and its description on a client terminal interface:
acquiring new description elements for the media within the client terminal;
transmitting the new description elements from the client terminal to the server;
updating the description of the media object within the server, taking into account the new description elements.

This method enables cooperative work for describing media objects, within a networked community. The new description elements may be contributed—either at the same time or not—by multiple members of the community, and integrate—either online or offline—into the common description stored on the server. The result is more interactivity in the work of creating the descriptions.

### BRIEF DESCRIPTION OF THE DRAWINGS

Other purposes and advantages of the invention will become apparent upon consideration of the description below, with reference to the attached drawing, which is a diagram depicting both the steps of a method and the architecture of a system 1 enabling the creation of descriptions of media objects.

### DETAILED DESCRIPTION OF THE INVENTION:

This system 1 comprises a server 2 and one or more client terminals 3 connected to the server 2 via one or more network connections, within a local area (LAN), metropolitan area (MAN), or wide-area (WAN) network 4, such as the Internet.

The server 2 comprises a first database 5 in which is stored at least one media object 6 (in practice, a multiplicity of media objects are stored in this database 5) such as video, audio, or images stored in the form of computer files that can be reconstructed on an interface of the terminal, using the appropriate codecs.

The server 2 comprises a second database 7, connected to the media database 5, in which is stored at least one semantic description 8 of the media object 6 (in practice, the database 7 comprises a multiplicity of descriptions 8 each associated with a media object 6 stored in the media database 5).

The description 8 may, for example, appear in the form of a set of metadata contained within a document written in XML (extended Markup Language). More precisely, the description may be written based on the MPEG-7 (Moving Picture Experts Group) standard, using the language DDL (Description Definition Language).

The server 2 further comprises a distribution module 9 connected to the databases 5, 7 and programmed to:
select both one or more media objects 6 from within the media database 5 and the corresponding description(s) 8 from the description database 8, and
transmit the selected media 6 accompanied by its description 8, to the terminal 3 or group of terminals connected to the server 2.

It should be noted that here, the term “module” encompasses any physical box incorporating a processor programmed to handle one or more predetermined functions, or any software application (program or subprogram, plug-in) implemented on a processor, either independently or in combination with other software applications.

Depending on the programming of the module 9, the mode of distribution may be unicast or broadcast.

The terminal 3 comprises a user interface 10 enabling the reconstruction, via an appropriate codec installed in the terminal 3 and through which the signal received from the server 2 travels, of the media 6 and its description 8.

The terminal 3 further comprises a control module 11 for performing a certain number of actions on the media 6 offline, such as pause, play, fast-forward, rewind, zoom, etc.

The terminal 3 also comprises an acquisition module 12, enabling a user of the terminal 3 to enter new description elements having a link to the media object 6.

These new description elements may:
complete the existing description 8, such as by entering additional data into preset fields in the form of information or comments, by replacing data in these same fields which is believed to be in error, or by creating new fields (XML and DDL languages, for example, have this advantage) and by adding new data to them,
or be entered into a new description document independent of the existing description 8.

The terminal 3 preferentially comprises a module 13 for synchronizing the media object 6 and the new description elements, connected to the control module 11 and enabling the user to contextually associate the new description elements thereby added with certain parts of the media object 6, based on time and/or space criteria (depending on the type of media in question). In this manner, for an image, the new elements may be associated with a selected area within this image. For an audio object, only the time criteria will be relevant, as the new elements entered by the user may be associated with moments—or intervals of time—chosen within the track. For a video, both criteria may, naturally, be combined.

The terminal 3 further comprises a communication interface 14 connected to both the acquisition module 12 and to the server 2 by a unicast link, potentially over the local, metropolitan, or wide area network 4. More precisely, the communication interface 14 is connected to a collection module 15 used for collect new description elements of the media object 6, said collection module 15 being connected to the description database 7.

The server 2 comprises an update module 16 for updating the description 8, taking into account the new elements collected. This update module 16 is connected to both the collection module 15 and to the description database 7.

In one embodiment depicted in the drawing, the terminal 2 comprises an authentication 17 module connected to a security manager 18 such as an AAA (Authentication, Authorization, Accounting) manager, to handle the functions of authentication, encryption, and invoicing. The security manager 18 may, for example, apply the RADIUS (Remote Authentication Dial-In User Service) protocol and appear either in the form of an independent server, or in the form of a module integrated into the server 2. This security manager 18 is connected to both the user profile database (not shown) and to the collection module 15.

The architecture just described makes it possible to create, fill out, and edit descriptions 8 of media objects 6 distributed from the server 2 to one or more terminals 3 in the manner described above.

A first step 100 consists of the server 2 selecting a media object 6 in the media object database 5 and the corresponding description 8 in the description 7 database. This selection may be performed automatically, in response to a request sent to the server 2 by one or more terminals 3 (whether at the same time or not). Within a VoD (Video on Demand) service, the terminal 3 that is subscribed to the service sends a request to download a video selected from a predefined list corresponding to all or some of the videos stored in the database 5.

A second step 200 consists of the server 2 transmitting the media 6, accompanied by its description, to the client terminal 3.

A third step 300 consists of the terminal 2, reconstructing the media 6 and its description 8 on its interface 10 (which may, for example, comprise a screen and/or one or more loudspeakers). A video, for example, is played on the screen, with the accompanying sound being reconstructed on the loudspeaker(s). The description 8 may also be reconstructed, either at the same time (such as by embedding text into the video image, or by displaying the text of the description in a special window), or at a different time (for example, at any time upon the request of the user).

A fourth step 400 consists of the terminal acquiring, via the acquisition module 12, new description elements for the media 6 that have been entered by the user. As seen above, this acquisition may be performed by editing the existing description 8 as sent to the terminal 3 by the server 2.

In one abovementioned embodiment, the description 8 may appear in the form of an XML or DDL document comprising tags and one or more pieces of text associated with the tags.

When the new description elements are acquired by editing the existing description 8 this acquisition may consist of adding tags and entering text into these tags; editing, annotating, or even deleting the text in the existing tags; or editing or deleting the tags themselves.

In one variant, the acquisition may be performed by creating a new description (for example, in the form of an XML or DDL document) intended to complete the existing description 8 by combining with it.

A fifth step 500 consists of the terminal 3, transmitting the new description elements to the server 2. The new description elements (contained within the modified initial description or within the new description to complete the initial description 8) are transmitted by the communication interface 14, in unicast mode, to the collection module 15.

The synchronization module 13 enables the user to synchronize the new description elements and the media object 6. For example, when adding a new subtitle to a video, the user may select a range of time during which the new subtitle is meant to be displayed.

This transmission step 500 may be accompanied by a step 550 of the server 2 authenticating the terminal 3. In practice, the step of sending the new description elements activates the security manager 18, which transmits an authentication request to the authentication module 17. In the event that the authentication implements a certificate, the authentication module 17 may automatically transmit the authentication elements to the manager 18. In one variant, the authentication may be accomplished by entering an identifier and a password onto the terminal, 3 and communicating them to the security manager 18.

Once the terminal 3 has been properly authenticated, a sixth step 600 consists of the server 2, updating the description 8 of the media object 6, taking into account the new description elements received from the terminal 3.

In the event that the collection module 15 receives a new version of the initial description from the terminal 3, including new description elements, the description 8 may be updated directly by the collection module 15, replacing the initial description 8 with its new version in the description database 7.

In the event that the collection module 15 receives new description elements from the terminal 3 in the form of a document separate from the existing description 8, the description 8 is updated by the update module 16, which combines the new description elements with the existing description 8.

In one embodiment, the updating of the description 8 is contingent on a quality control for the new description elements. Such a control may be performed in different ways:
automatically by the server 2; for example, within the collection module 15: it is possible to program the collection module 15 so that certain prohibited terms are deleted from the new description elements that have been submitted, or to block these elements, in the event that they contain prohibited terms;
by one or more administrators having access to the server 2 and being tasked with reviewing the new description elements;
or collaboratively, by a community of users to whom the new description elements are submitted for approval, either systematically or whenever the description elements originate from one or more predefined terminals whose users are intended to be subjected to controls by the other members of the community.

In the latter case, an additional step is provided for, consisting of transmitting the new description elements to one or more terminals 3 (corresponding to the community or to one part thereof) connected to the server 2, followed by a quality control step conducted within said terminal(s) 3. The approved (or corrected) elements are then resent by the terminal(s) 3 in question to the server 2 to update the description 8.

The method just described (and the architecture of the system 1 enabling its implementation) exhibits a certain number of advantages.

It makes it possible to create descriptions thanks to the cooperative contributions of a community (potentially a restricted one) working over a network. This cooperative work makes it possible not only to substantially increase the content of the descriptions created, but also to improve their high-level abstraction quality. In particular, owing to the function of combining/updating the descriptions, multiple members of the community may work on a single description simultaneously, with each new contribution being taken into account to reconstruct a complete and up-to-date description.

It should be noted that this method may be adapted to various types of communities, depending on their operating mode: free, pay, or mixed. It is possible to incorporate one or more economic models into the method, which may, for example, consist of rewarding or compensating certain members of the community who distinguish themselves by the quantity or quality of their contributions. To that end, an appropriate billing service may be programmed within the manager 18.

1. A method for the description of a media object (6), said method comprising the following steps:
selecting a media object (6) from within a server (2) and a description (8) of said media object (6);
transmitting the media (6), accompanied by its description (6), to a client terminal (3) connected to the server (2);
reconstructing the media object (6) and its description (8) on one interface (10) of the terminal (3);
acquiring new description elements of the media (6) within the terminal (3);
transmitting the new description elements from the terminal (3) to the server (2);
transmitting the new description elements to one or more terminals (3) connected to the server (2);
performing, within said terminal(s) (3), a quality control on the new description elements;
approving or correcting said elements;
retransmitting the approved or corrected elements to the server (2);
updating the description (8) of the media object (6) within the server (2), taking into account the new description elements.

2. A method according to claim 1, comprising a step of authenticating the terminal (3), the updating of the description (8) being contingent on the authentication of the terminal (3) by the server (2).

3. A method according to claim 1, in which the acquisition of the new description elements consists of incorporating them into the existing description (8), the updating consisting of replacing the existing description (8) with the new description including the new description elements.

4. A method according to claim 1, in which the acquisition of new description elements consists of creating a new document, the updating consisting of combining the new description elements with the existing description (8).

5. A method according to claim 3, which comprises, within the terminal, (3) a step of synchronizing the new description elements with the media object (6).

6. A method according to claim 1, in which the description (8) of the media (6) is contained within a document written in an XML markup language.
